(19) United States
(12) Patent Application Publication
(10) Pub. No.: US 2024/0237631 A1
(43) Pub. Date: Jul. 18, 2024

(54) Mousetrap Assembly

(71) Applicant: Jon Reiten, Potosi, WI (US)

(72) Inventor: Jon Reiten, Potosi, WI (US)

(21) Appl. No.: 18/098,562

(22) Filed: Jan. 18, 2023

(51) Int. Cl. A01M 23/30; A01M 23/02

(52) U.S. Cl. CPC A01M 23/30; A01M 23/02

(57) ABSTRACT

A mousetrap assembly includes a mousetrap that has a platform, a bait tray, a pair of snap bars and a trip wire. Each of the snap bars is biased into a first position and each of the snap bars is urgeable into a second position. The trip wire is positionable to extend across each of the snap bars when the pair of snap bars is in the second position. The trip wire disengages the bait tray to facilitate each of the snap bars to be biased into the first position to crush the mouse. A bag is extendable through each of the snap bars to require the mouse to enter into the bag to access the bait tray. The bag contains the mouse when the mouse is crushed by a respective snap bar to facilitate a user to remove the mouse from the mousetrap without has to touch the mouse.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to mousetrap devices and more particularly pertains to a new mousetrap device for killing and containing a mouse. The device includes a mousetrap that includes a pair of snap bars, a trip wire and a bait tray. The device includes a bag that is extendable through the pair of snap bars to lie on the bait tray. A respective one of the snap bars crushes the mouse and a respective one of the snap bars closes the bag when the mouse moves onto the bait tray.

### (2) Description of Related Art Including Information Disclosed Under 37 CFR 1.97 and 1.98

The prior art relates to mousetrap devices including a portable electric mouse trap that includes a housing with the ornamental appearance of a house cat. The prior art discloses a mechanized mouse trap that includes a housing, a bait tray, a snap bar and a plurality of gears between the bait tray and the snap bar. The prior art discloses a mouse trap that includes a bait tray, a trip wire and a single snap bar. The prior art discloses a mouse trap that includes a housing, a trap disposed in the housing and a viewing window in the housing. The prior art discloses a mouse trap that includes a safety arm to prevent accidental discharge of a snap arm.

### BRIEF SUMMARY OF THE INVENTION

An embodiment of the disclosure meets the needs presented above by generally comprising a mousetrap that has a platform, a bait tray, a pair of snap bars and a trip wire. Each of the snap bars is biased into a first position and each of the snap bars is urgeable into a second position. The trip wire is positionable to extend across each of the snap bars when the pair of snap bars is in the second position. The trip wire disengages the bait tray to facilitate each of the snap bars to be biased into the first position to crush the mouse. A bag is extendable through each of the snap bars to require the mouse to enter into the bag to access the bait tray. The bag contains the mouse when the mouse is crushed by a respective snap bar to facilitate a user to remove the mouse from the mousetrap without has to touch the mouse.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a mousetrap assembly according to an embodiment of the disclosure.

FIG. 2 is a perspective view of an embodiment of the disclosure showing a bag being inserted through a pair of snap bars.

FIG. 3 is a top view of an embodiment of the disclosure.

FIG. 4 is a left side view of an embodiment of the disclosure.

FIG. 5 is a front view of an embodiment of the disclosure.

FIG. 6 is a back view of an embodiment of the disclosure.

FIG. 7 is a perspective in-use view of an embodiment of the disclosure showing a mouse entering a bag.

FIG. 8 is a perspective in-use view of an embodiment of the disclosure showing a mouse being inside a bag.

FIG. 9 is a perspective in-use view of an embodiment of the disclosure showing a trip wire being disengaged from a bait tray.

FIG. 10 is a perspective in-use view of an embodiment of the disclosure showing a mouse being crushed by a snap bar.

FIG. 11 is a perspective in-use view of an embodiment of the disclosure showing a bag containing a mouse being removed from a mousetrap.

FIG. 12 is a perspective view of an alternative embodiment of the disclosure.

### DETAILED DESCRIPTION OF THE INVENTION

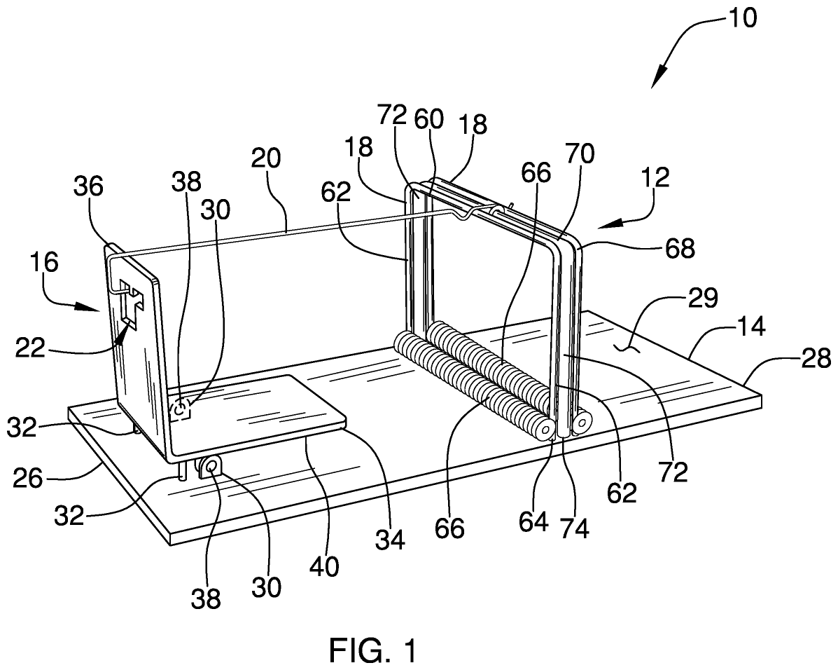

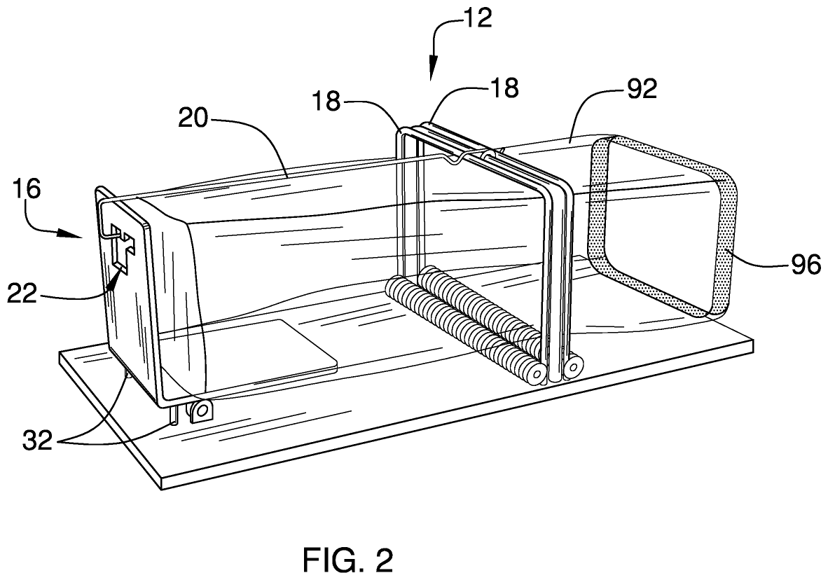

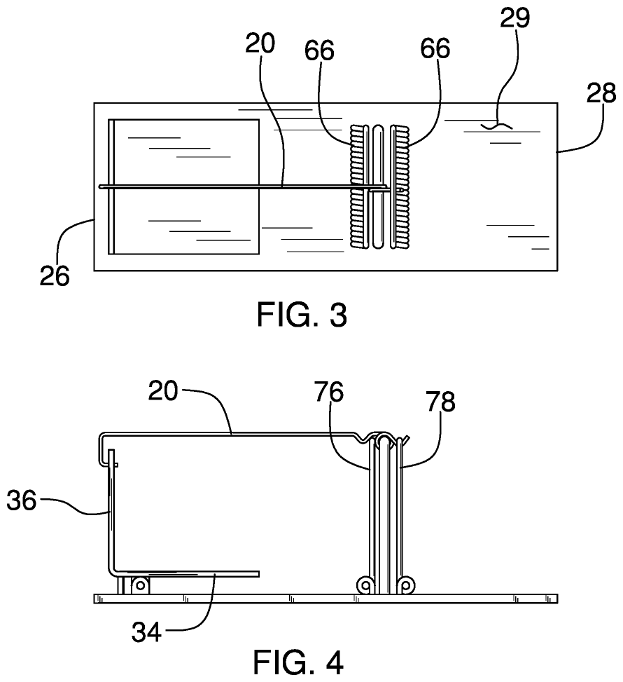

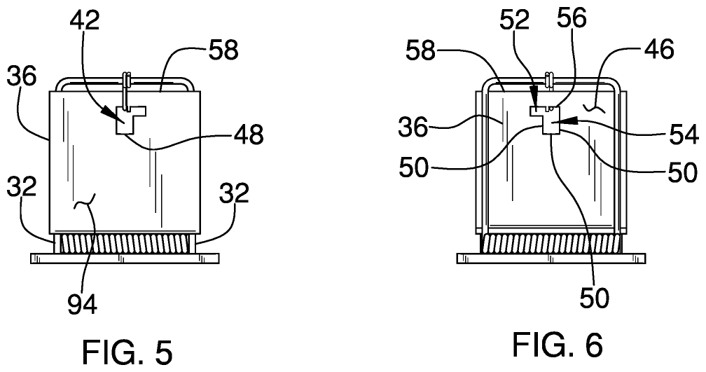

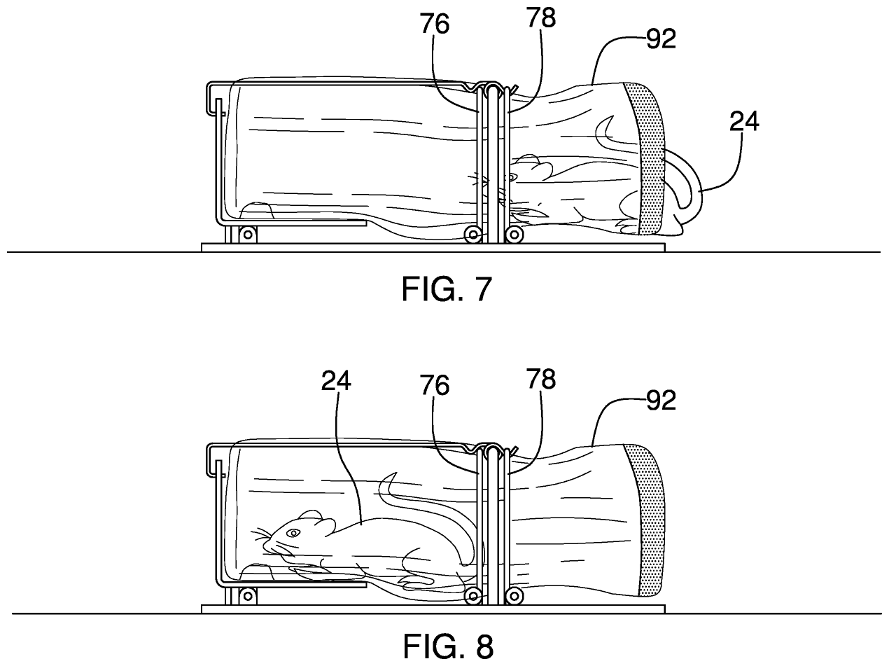

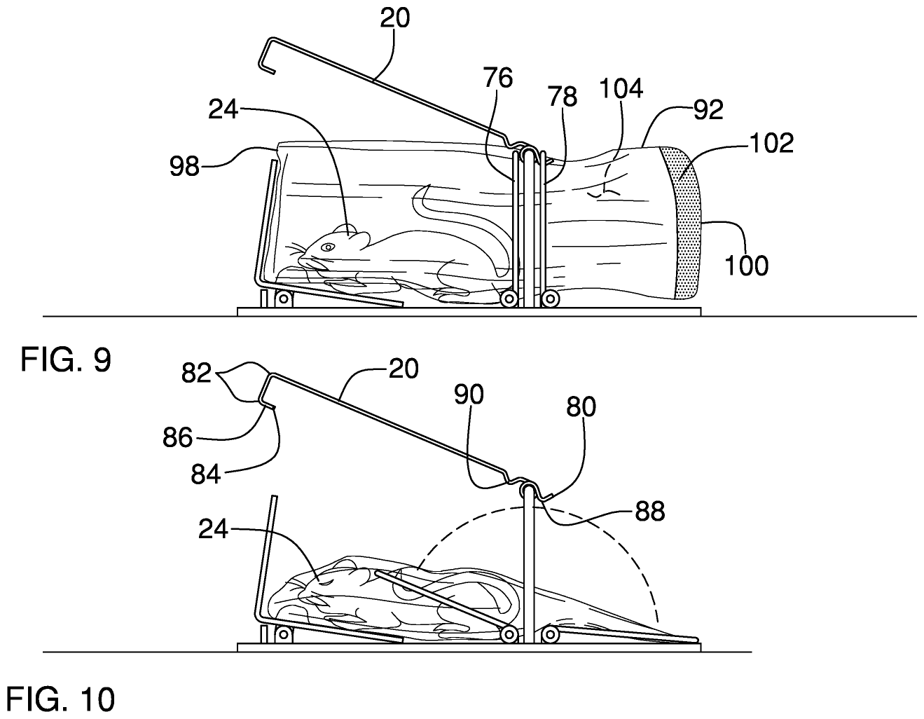

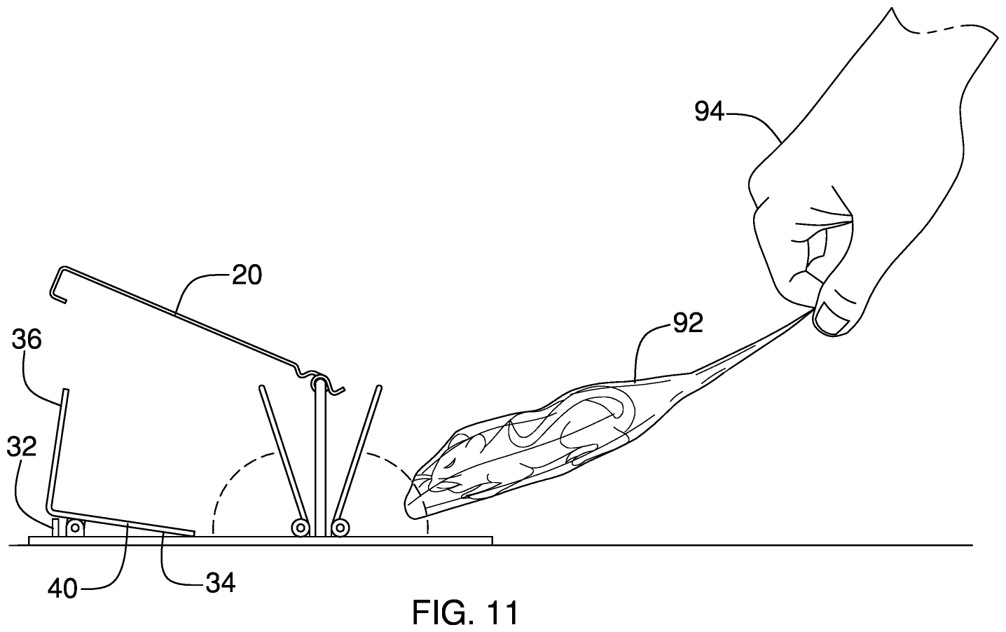

With reference now to the drawings, and in particular to FIGS. 1 through 12 thereof, a new mousetrap device embodying the principles and concepts of an embodiment of the disclosure and generally designated by the reference numeral 10 will be described.

As best illustrated in FIGS. 1 through 12, the mousetrap assembly 10 generally comprises a mousetrap 12 that has a platform 14, a bait tray 16, a pair of snap bars 18 and a trip wire 20. Each of the snap bars 18 is pivotally attached to the platform 14 and each of the snap bars 18 is biased into a first position having each of the snap bars 18 resting against the platform 14. Each of the snap bars 18 is urgeable into a second position having each of the snap bars 18 extending upwardly from the platform 14. Additionally, each of the snap bars 18 extends in opposite directions from each other when the snap bars 18 are biased into the first position.

The trip wire 20 is positionable in a retaining position having the trip wire 20 extending across each of the snap bars 18 when the pair of snap bars 18 is in the second position. The trip wire 20 releasably engages an engagement point 22 in the bait tray 16 when the trip wire 20 is positioned in the retaining position for retaining the trip wire 20 in the retaining position. Conversely, the trip wire 20 disengages the engagement point 22 in the bait tray 16 when a mouse 24 moves onto the bait tray 16 thereby facilitating each of the snap bars 18 to be biased into the first position. In this way a respective one of the snap bars 18 is urged to crush a mouse 24 when the mouse 24 moves onto the mousetrap 12.

The platform 14 has a first end 26, a second end 28 and a top surface 29 extending between the first end 26 and the second end 28 and the platform 14 is elongated between the first end 26 and the second end 28. The platform 14 has a pair of pivots 30 each extending upwardly from the top surface 29 and each of the pivots 30 is positioned closer to the first end 26 than the second end 28. The platform 14 has a pair of stops 32 each extending upwardly from the top surface 29 and each of the stops 32 is aligned with a respective one of the pivots 30. Each of the stops 32 is positioned between the respective pivot 30 and the first end 26 of the platform 14.

The bait tray 16 has a first panel 34 forming an angle with a second panel 36. The bait tray 16 has a pair of pivot engagements 38 each extending downwardly from a bottom surface 40 of the first panel 34. Each of the pivot engagements 38 pivotally engages a respective one of the pivots 30 on the top surface 29 of the platform 14 such that the second panel 36 is directed upwardly from the first panel 34. The second panel 36 has an opening 42 extending through a front surface 44 and a back surface 46 of the second panel 36 such that the opening 42 defines the engagement point 22 in the bait tray 16. The opening 42 has a bounding surface 48 which has a plurality of intersecting sides 50 each intersecting each other at right angles to define a square 52 extending laterally away from a rectangle 54. Additionally, the plurality of intersecting sides 50 defines a tab 56 extending downwardly into the rectangle 54 and the opening 42 is spaced from a distal edge 58 of the second panel 36 with respect to the first panel 34. The bottom surface 40 of the first panel 34 rests on each of the stops 32 such that the second panel 36 is vertically oriented when the bait tray 16 is positioned in a first position. The first panel 34 pivots on the pivots 30 such that the bottom surface 40 of the first panel 34 is displaced from the stops 32 having the second panel 36 angling toward the second end 28 of the platform 14 when the bait tray 16 is positioned in a second position.

Each of the snap bars 18 has a central member 60 extending between a pair of outward members 62 and each of the outward members 62 of a respective one of the snap bars 18 is perpendicularly oriented with the central member 60 of the respective snap bar 18. Each of the outward members 62 of each of the snap bars 18 has a bottom end 64. A pair of biasing members 66 is provided and each of the biasing members 66 is attached to the top surface 29 of the platform 14. Each of the biasing members 66 engages the pair of outward members 62 of a respective one of the snap bars 18 at a point located adjacent to the bottom end 64 of the outward members 62 of the respective snap bar 18. Additionally, each of the biasing members 66 biases the respective snap bar 18 into the first position having the central member 60 of each of the snap bars 18 abutting the top surface 29 of the platform 14. Each of the outward members 62 of each of the snap bars 18 is vertically oriented having the central member 60 of each of the snap bars 18 being spaced from the top surface 29 of the platform 14 when the snap bars 18 are in the second position. Furthermore, each of the biasing members 66 is positioned between the bait tray 16 and the second end 28 of the platform 14.

A stabilizer 68 is provided that has a middle member 70 extending between a pair of lateral members 72 and each of the lateral members 72 is perpendicularly oriented with the middle member 70. Each of the lateral members 72 has a lower end 74 that is coupled to the top surface 29 of the platform 14 such that the middle member 70 is elevated from the top surface 29. Each of the lateral members 72 is positioned between the pair of biasing members 66. Each of the outward members 62 of each of the snap bars 18 extends upwardly along a respective one of the lateral members 72 having the central member 60 of each of the snap bars 18 extending along the middle member 70 when the snap bars 18 are in the second position. Each of the snap bars 18 is positioned on opposing sides of the stabilizer 68 with respect to each other and the pair of snap bars 18 includes a first snap bar 76 and a second snap bar 78. The central member 60 of the first snap bar 76 rests on the first panel 34 of the bait tray 16 when the first snap bar 76 is biased into the first position to crush the mouse 24. The central member 60 of the second snap bar 78 rests on the top surface 29 of the platform 14 at a point located adjacent to the second end 28 of the platform 14 when the second snap bar 78 is biased into the first position.

The trip wire 20 is wrapped around the middle member 70 of the stabilizer 68 at a point located proximate a back end 80 of the trip wire 20 such that the trip wire 20 is pivotally attached to the middle member 70 of the stabilizer 68. The trip wire 20 has a pair of bends 82 each located proximate a front end 84 of the trip wire 20 to define a foot 86 on the trip wire 20 that is extendable through the opening 42 in the second panel 36 of the bait tray 16. In this way the bait tray 16 is retained in the first position and the trip wire 20 is retained in the in the retaining position. The bait tray 16 is urged into the second position when the mouse 24 moves onto the first panel 34 of the bait tray 16 thereby releasing the foot 86 from the opening 42 in the second panel 36 of the bait tray 16.

The trip wire 20 has a first curve 88 that is located adjacent to the back end 80 of the trip wire 20. The first curve 88 is directed downwardly such that the central member 60 of the second snap bar 78 is positioned in the first curve 88 when the trip wire 20 is positioned in the retaining position for retaining the second snap bar 78 in the first position. The trip wire 20 has a second curve 90 that is positioned in between the middle member 70 of the stabilizer 68 and the pair of bends 82 in the trip wire 20. The second curve 90 is directed downwardly such that the central member 60 of the first snap bar 76 abuts the second curve 90 when the trip wire 20 is positioned in the retaining position for retaining the first snap bar 76 in the first position.

The first curve 88 moves downwardly from the middle member 70 of the second snap bar 78 when the foot 86 on the trip wire 20 disengages the opening 42 in the second panel 36 of the bait tray 16. In this way the second snap bar 78 can be biased into the second position. The second curve 90 moves upwardly from the middle member 70 of the first snap bar 76 when the foot 86 on the trip wire 20 disengages the opening 42 in the second panel 36 of the bait tray 16. In this way the first snap bar 76 can be biased into the second position.

A bag 92 is provided and the bag 92 is extendable through each of the snap bars 18 such that the bag 92 rests on the bait tray 16. In this way the mouse 24 is required to enter into the bag 92 to travel to the bait tray 16 such that the bag 92 contains the mouse 24 when the mouse 24 is crushed by a respective snap bar 18. Thus, the bag 92 facilitates a user 94 to remove the mouse 24 from the mousetrap 12 without having to touch the mouse 24. The bag 92 has a closure 96 that is engaged by a respective one of the snap bars 18 when the respective snap bar 18 is biased into the first position thereby sealing the bag 92. In this way the bag 92 inhibits odors produced by the mouse 24 from escaping the bag 92.

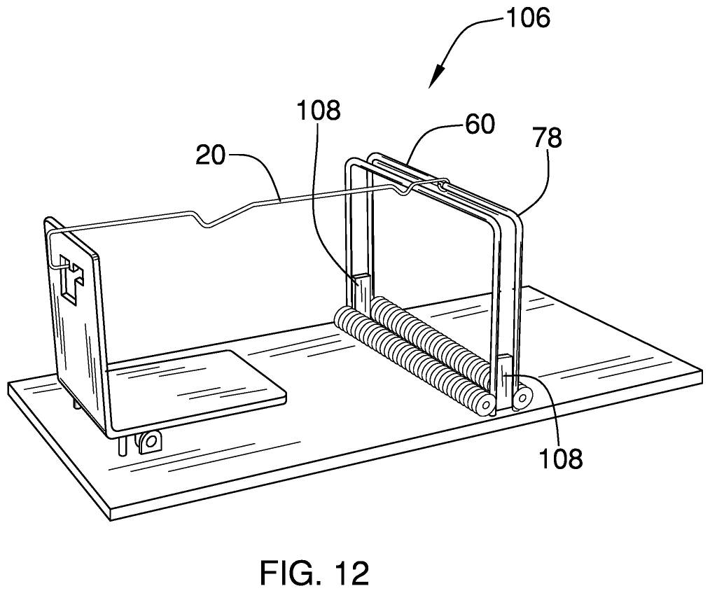

The bag 92 has a front end 98 and a back end 100 and the back end 100 of the bag 92 is open. The front end 98 lies on the first panel 34 of the bait tray 16 when the bag 92 is extended through the first snap bar 76 and the second snap bar 78. The back end 80 of the bag 92 lies on the top surface 29 of the platform 14 at a point that is located adjacent to the second end 28 of the platform 14 when the bag 92 is extended through the first snap bar 76 and the second snap bar 78. The bag 92 has an adhesive strip 102 that is applied to an interior surface 104 of the bag 92 at a point located adjacent to the back end 80 of the bag 92 and the adhesive strip 102 defines the closure 96. The second snap bar 78 compresses the bag 92 onto itself when the second snap bar 78 is biased into the second position thereby facilitating the adhesive strip 102 to adhere to itself for closing the back end 80 of the bag 92. In an alternative embodiment 106 as is most clearly shown in FIG. 12, the stabilizer 68 comprises a pair of stems 108 each extending upwardly from the top surface 29 of the platform 14. The trip wire 20 is wrapped around the central member 60 of the second snap bar 78.

In use, each of the first snap bar 76 and the second snap bar 78 are urged into the first position and the foot 86 on the trip wire 20 is extended through the opening 42 in the second panel 36 of the bait tray 16. In this way the first snap bar 76 and the second snap bar 78 are retained in the first position and the bait tray 16 is retained in the first position. Bait 104 is positioned in the bag 92 and the bag 92 is extended through each of the first snap bar 76 and the second snap bar 78 to position the bait on the bait tray 16. In this way the mouse 24 enters through the back end 80 of the bag 92 to access the bait 104. The mouse 24 lowers the bait tray 16 into the second position thereby releasing the trip wire 20 from the opening 42 to facilitate each of the first snap bar 76 and the second snap bar 78 to be biased into the second position. In this way the first snap bar 76 crushes the mouse 24 and the second snap bar 78 closes the bag 92 such that the adhesive strip 102 adheres to itself. In this way the bag 92 can be removed from the mousetrap 12 to dispose of the mouse 24 without requiring the user 94 to touch the mouse 24.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mousetrap assembly for killing a mouse and storing the dead mouse in a bag for disposal, said assembly comprising:
a mousetrap having a platform, a bait tray, a pair of snap bars and a trip wire, each of said snap bars being pivotally attached to said platform, each of said snap bars being biased into a first position having each of said snap bars resting against said platform, each of said snap bars being urgeable into a second position having each of said snap bars extending upwardly from said platform, each of said snap bars extending in opposite directions from each other when said snap bars are biased into said first position, said trip wire being positionable in a retaining position having said trip wire extending across each of said snap bars when said pair of snap bars is in said second position, said trip wire releasably engaging an engagement point in said bait tray when said trip wire is positioned in said retaining position for retaining said trip wire in said retaining position, said trip wire disengaging said engagement point in said bait tray when a mouse moves onto said bait tray thereby facilitating each of said snap bars to be biased into said first position wherein a respective one of said snap bars is configured to crush the mouse; and
a bag being extendable through each of said snap bars such that said bag rests on said bait tray thereby requiring the mouse to enter into said bag to travel to said bait tray such that said bag contains the mouse when the mouse is crushed by a respective snap bar wherein said bag is configured to facilitate a user to remove the mouse from said mousetrap without having to touch the mouse, said bag having a closure being engaged by a respective one of said snap bars when said respective snap bar is biased into said first position thereby sealing said bag wherein said bag is configured to inhibit odors produced by the mouse from escaping said bag.

2. The assembly according to claim 1, wherein:
said platform has a first end, a second end and a top surface extending between said first end and said second end, said platform being elongated between said first end and said second end;
said platform has a pair of pivots each extending upwardly from said top surface, each of said pivots being positioned closer to said first end than said second end;
said platform has a pair of stops each extending upwardly from said top surface, each of said stops being aligned with a respective one of said pivots, each of said stops being positioned between said respective pivot and said first end of said platform; and
said bait tray has a first panel forming an angle with a second panel, said bait tray having a pair of pivot engagements each extending downwardly from a bottom surface of said first panel, each of said pivot engagements pivotally engaging a respective one of said pivots on said top surface of said platform such that said second panel is directed upwardly from said first panel.

3. The assembly according to claim 2, wherein said second panel has an opening extending through a front surface and a back surface of said second panel such that said opening defines said engagement point in said bait tray, said opening having a bounding surface which has a plurality of intersecting sides each intersecting each other at right angles to define a square extending laterally away from a rectangle, said plurality of intersecting sides defining a tab extending downwardly into said rectangle, said opening being spaced from a distal edge of said second panel with respect to said first panel.

4. The assembly according to claim 2, wherein said bottom surface of said first panel rests on each of said stops such that said second panel is vertically oriented when said bait tray is positioned in a first position, said first panel pivoting on said pivots such that said bottom surface of said first panel is displaced from said stops having said second panel angling toward said second end of said platform when said bait tray is positioned in a second position.

5. The assembly according to claim 2, wherein:
each of said snap bars has a central member extending between a pair of outward members, each of said outward members of a respective one of said snap bars being perpendicularly oriented with said central member of said respective snap bar, each of said outward members of each of said snap bars having a bottom end;
said assembly includes a pair of biasing members, each of said biasing members being attached to said top surface of said platform, each of said biasing members engaging said pair of outward members of a respective one of said snap bars at a point located adjacent to said bottom end of said outward members of said respective snap bar;
each of said biasing members biases said respective snap bar into said first position having said central member of each of said snap bars abutting said top surface of said platform;
each of said outward members of each of said snap bars is vertically oriented having said central member of each of said snap bars being spaced from said top surface of said platform when said snap bars are in said second position; and
each of said biasing members is positioned between said bait tray and said second end of said platform.

6. The assembly according to claim 5, further comprising a stabilizer having a middle member extending between a pair of lateral members, each of said lateral members being perpendicularly oriented with said middle member, each of said lateral members having a lower end being coupled to said top surface of said platform such that said middle member is elevated from said top surface, each of said lateral members being positioned between said pair of biasing members, each of said outward members of each of said snap bars extending upwardly along a respective one of said lateral members having said central members of each of said snap bars extending along said middle member when said snap bars are in said second position, each of said snap bars being positioned on opposing sides of said stabilizer with respect to each other.

7. The assembly according to claim 5, wherein said pair of snap bars includes a first snap bar and a second snap bar, said central member of said first snap bar resting on said first panel of said bait tray when said first snap bar is biased into said first position wherein said central member of said first snap bar is configured to crush the mouse, said central member of said second snap bar resting on said top surface of said platform at a point located adjacent to said second end of said platform when said second snap bar is biased into said first position.

8. The assembly according to claim 6, wherein:
said bait tray has a first panel forming an angle with a second panel, said second panel having an opening extending through a front surface and a back surface of said second panel such that said opening defines said engagement point in said bait tray; and
said trip wire is wrapped around said middle member of said stabilizer at a point located proximate a back end of said trip wire such that said trip wire is pivotally attached to said middle member of said stabilizer, said trip wire having a pair of bends each located proximate a front end of said trip wire to define a foot on said trip wire that is extendable through said opening in said second panel of said bait tray thereby retaining said bait tray in said first position and thereby retaining said trip wire in said in said retaining position.

9. The assembly according to claim 8, wherein said bait tray is urged into said second position when the mouse moves onto said first panel of said bait tray thereby releasing said foot from said opening in said second panel of said bait tray.

10. The assembly according to claim 9, wherein:
said pair of snap bars includes a first snap bar and a second snap bar; and
said trip wire has a first curve being located adjacent to said back end of said trip wire, said first curve being directed downwardly such that said central member of said second snap bar is positioned in said first curve when said trip wire is positioned in said retaining position for retaining said second snap bar in said first position.

11. The assembly according to claim 10, wherein said trip wire has a second curve being positioned in between said middle member of said stabilizer and said pair of bends in said trip wire, said second curve being directed downwardly such that said central member of said first snap bar abuts said second curve when said trip wire is positioned in said retaining position for retaining said first snap bar in said first position.

12. The assembly according to claim 11, wherein:
said first curve moves downwardly from said middle member of said second snap bar when said foot on said trip wire disengages said opening in said second panel of said bait tray thereby facilitating said second snap bar to be biased into said second position; and
said second curve moves upwardly from said middle member of said first snap bar when said foot on said trip wire disengages said opening in said second panel of said bait tray thereby facilitating said first snap bar to be biased into said second position.

13. The assembly according to claim 7, wherein said bag has a front end and a back end, said back end being open, said front end lying on said first panel of said bait tray when said bag is extended through said first snap bar and said second snap bar, said back end of said bag lying on said top surface of said platform at a point located adjacent to said second end of said platform when said bag is extended through said first snap bar and said second snap bar.

14. The assembly according to claim 13, wherein said bag has an adhesive strip being applied to an interior surface of said bag at a point located adjacent to said back end of said bag, said second snap bar compressing said bag onto itself when said second snap bar is biased into said second position thereby facilitating said adhesive strip to adhere to itself for closing said back end of said bag.

15. A mousetrap assembly for killing a mouse and storing the dead mouse in a bag for disposal, said assembly comprising:
a mousetrap having a platform, a bait tray, a pair of snap bars and a trip wire, each of said snap bars being pivotally attached to said platform, each of said snap bars being biased into a first position having each of said snap bars resting against said platform, each of said snap bars being urgeable into a second position having each of said snap bars extending upwardly from said platform, each of said snap bars extending in opposite directions from each other when said snap bars are biased into said first position, said trip wire being positionable in a retaining position having said trip wire extending across each of said snap bars when said pair of snap bars is in said second position, said trip wire releasably engaging an engagement point in said bait tray when said trip wire is positioned in said retaining position for retaining said trip wire in said retaining position, said trip wire disengaging said engagement point in said bait tray when a mouse moves onto said bait tray thereby facilitating each of said snap bars to be biased into said first position wherein a respective one of said snap bars is configured to crush the mouse, said platform having a first end, a second end and a top surface extending between said first end and said second end, said platform being elongated between said first end and said second end, said platform having a pair of pivots each extending upwardly from said top surface, each of said pivots being positioned closer to said first end than said second end, said platform having a pair of stops each extending upwardly from said top surface, each of said stops being aligned with a respective one of said pivots, each of said stops being positioned between said respective pivot and said first end of said platform, said bait tray having a first panel forming an angle with a second panel, said bait tray having a pair of pivot engagements each extending downwardly from a bottom surface of said first panel, each of said pivot engagements pivotally engaging a respective one of said pivots on said top surface of said platform such that said second panel is directed upwardly from said first panel, said second panel having an opening extending through a front surface and a back surface of said second panel such that said opening defines said engagement point in said bait tray, said opening having a bounding surface which has a plurality of intersecting sides each intersecting each other at right angles to define a square extending laterally away from a rectangle, said plurality of intersecting sides defining a tab extending downwardly into said rectangle, said opening being spaced from a distal edge of said second panel with respect to said first panel, said bottom surface of said first panel resting on each of said stops such that said second panel is vertically oriented when said bait tray is positioned in a first position, said first panel pivoting on said pivots such that said bottom surface of said first panel is displaced from said stops having said second panel angling toward said second end of said platform when said bait tray is positioned in a second position, each of said snap bars having a central member extending between a pair of outward members, each of said outward members of a respective one of said snap bars being perpendicularly oriented with said central member of said respective snap bar, each of said outward members of each of said snap bars having a bottom end;
a pair of biasing members, each of said biasing members being attached to said top surface of said platform, each of said biasing members engaging said pair of outward members of a respective one of said snap bars at a point located adjacent to said bottom end of said outward members of said respective snap bar, each of said biasing members biasing said respective snap bar into said first position having said central member of each of said snap bars abutting said top surface of said platform, each of said outward members of each of said snap bars being vertically oriented having said central member of each of said snap bars being spaced from said top surface of said platform when said snap bars are in said second position, each of said biasing members being positioned between said bait tray and said second end of said platform;
a stabilizer having a middle member extending between a pair of lateral members, each of said lateral members being perpendicularly oriented with said middle member, each of said lateral members having a lower end being coupled to said top surface of said platform such that said middle member is elevated from said top surface, each of said lateral members being positioned between said pair of biasing members, each of said outward members of each of said snap bars extending upwardly along a respective one of said lateral members having said central members of each of said snap bars extending along said middle member when said snap bars are in said second position, each of said snap bars being positioned on opposing sides of said stabilizer with respect to each other, said pair of snap bars including a first snap bar and a second snap bar, said central member of said first snap bar resting on said first panel of said bait tray when said first snap bar is biased into said first position wherein said central member of said first snap bar is configured to crush the mouse, said central member of said second snap bar resting on said top surface of said platform at a point located adjacent to said second end of said platform when said second snap bar is biased into said first position, said trip wire being wrapped around said middle member of said stabilizer at a point located proximate a back end of said trip wire such that said trip wire is pivotally attached to said middle member of said stabilizer, said trip wire having a pair of bends each located proximate a front end of said trip wire to define a foot on said trip wire that is extendable through said opening in said second panel of said bait tray thereby retaining said bait tray in said first position and thereby retaining said trip wire in said in said retaining position, said bait tray being urged into said second position when the mouse moves onto said first panel of said bait tray thereby releasing said foot from said opening in said second panel of said bait tray, said trip wire having a first curve being located adjacent to said back end of said trip wire, said first curve being directed downwardly such that said central member of said second snap bar is positioned in said first curve when said trip wire is positioned in said retaining position for retaining said second snap bar in said first position, said trip wire having a second curve being positioned in between said middle member of said stabilizer and said pair of bends in said trip wire, said second curve being directed downwardly such that said central member of said first snap bar abuts said second curve when said trip wire is positioned in said retaining position for retaining said first snap bar in said first position, said first curve moving downwardly from said middle member of said second snap bar when said foot on said trip wire disengages said opening in said second panel of said bait tray thereby facilitating said second snap bar to be biased into said second position, said second curve moving upwardly from said middle member of said first snap bar when said foot on said trip wire disengages said opening in said second panel of said bait tray thereby facilitating said first snap bar to be biased into said second position; and
a bag being extendable through each of said snap bars such that said bag rests on said bait tray thereby requiring the mouse to enter into said bag to travel to said bait tray such that said bag contains the mouse when the mouse is crushed by a respective snap bar wherein said bag is configured to facilitate a user to remove the mouse from said mousetrap without having to touch the mouse, said bag having a closure being engaged by a respective one of said snap bars when said respective snap bar is biased into said first position thereby sealing said bag wherein said bag is configured to inhibit odors produced by the mouse from escaping said bag, said bag having a front end and a back end, said back end being open, said front end lying on said first panel of said bait tray when said bag is extended through said first snap bar and said second snap bar, said back end of said bag lying on said top surface of said platform at a point located adjacent to said second end of said platform when said bag is extended through said first snap bar and said second snap bar, said bag having an adhesive strip being applied to an interior surface of said bag at a point located adjacent to said back end of said bag, said second snap bar compressing said bag onto itself when said second snap bar is biased into said second position thereby facilitating said adhesive strip to adhere to itself for closing said back end of said bag.

16. The assembly according to claim 15, wherein:
said stabilizer comprises a pair of stems each extending upwardly from said top surface of said platform; and
said trip wire is wrapped around said central member of said second snap bar.
